(19) United States
(12) Patent Application Publication
(10) Pub. No.: US 2021/0200298 A1
(43) Pub. Date: Jul. 1, 2021

(54) LONG-IDLE STATE SYSTEM AND METHOD

(71) Applicant: Advanced Micro Devices, Inc., Santa Clara, CA (US)

(72) Inventors: Alexander J. Branover, Boxborough, MA (US); Benjamin Tsien, Santa Clara, CA (US)

(73) Assignee: Advanced Micro Devices, Inc., Santa Clara, CA (US)

(21) Appl. No.: 16/730,252

(22) Filed: Dec. 30, 2019

(51) Int. Cl. G06F 1/3234; G06F 13/16; G06F 9/4401; G06F 13/28; G06F 1/3296; G06F 1/3287

(52) U.S. Cl. CPC G06F 1/3275; G06F 13/1668; G06F 1/3287; G06F 13/28; G06F 1/3296; G06F 9/4418

(57) ABSTRACT

Methods, devices and systems for power management in a computer processing device are disclosed. The methods may include selecting, by a data fabric, D23 as target state, selecting D3 state by a memory controller, blocking memory access, reducing data fabric and memory controller clocks, reduce SoC voltage, and turning PHY voltage off. The methods may include signaling to wake up the SoC, starting exit flow by ramping up SoC voltage and ramping data fabric and memory controller clocks, unblocking memory access, propagating activity associated with the wake up event to memory, exiting D3 by PHY, and exiting self-refresh by a memory.

### BACKGROUND

A computer processor is described as idle when it is not being used by any program. Every program or task that runs on a computer system occupies a certain amount of processing time on the central processing unit (CPU). If the CPU has completed all tasks it is idle. Modern processors use idle time to save power. Common methods of saving power include reducing the clock speed and the CPU voltage, and sending parts of the processor into a sleep state. The management of power savings and the ability to quickly wake to operation has required a careful balancing in computer systems.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of the device of FIG. 1, illustrating additional detail;

FIG. 3 is a block diagram illustrating an example system-on-a-chip (SoC) device in which one or more features of the disclosure can be implemented;

FIG. 4 illustrates a method of entering D23 state; and

FIG. 5 illustrates a method of exiting D23 state.

### DETAILED DESCRIPTION

Methods, devices and systems for power management in a computer processing device are disclosed. The methods may include selecting, by a data fabric, D23 as a target state, selecting a D3 state by a memory controller, blocking memory access, reducing data fabric and memory controller clocks, reduce system-on-a-chip (SoC) voltage, and turning the physical interface (PHY) voltage off. The methods may include signaling to wake up the SoC, starting exit flow by ramping up SoC voltage and ramping data fabric and memory controller clocks, unblocking memory access, propagating activity associated with the wake up event to memory, exiting the D3 state by the PHY, and exiting self-refresh by a memory.

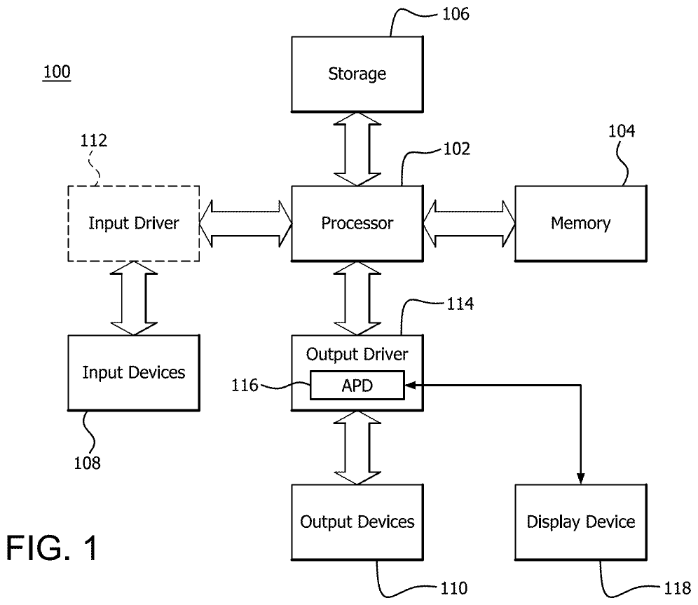

FIG. 1 is a block diagram of an example device 100 in which one or more features of the disclosure can be implemented. The device 100 can include, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 can also optionally include an input driver 112 and an output driver 114. It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present. The output driver 116 includes an accelerated processing device (“APD”) 116 which is coupled to a display device 118. The APD accepts compute commands and graphics rendering commands from processor 102, processes those compute and graphics rendering commands, and provides pixel output to display device 118 for display. As described in further detail below, the APD 116 includes one or more parallel processing units to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and provides graphical output to a display device 118. For example, it is contemplated that any processing system that performs processing tasks in accordance with a SIMD paradigm may perform the functionality described herein. Alternatively, it is contemplated that computing systems that do not perform processing tasks in accordance with a SIMD paradigm performs the functionality described herein.

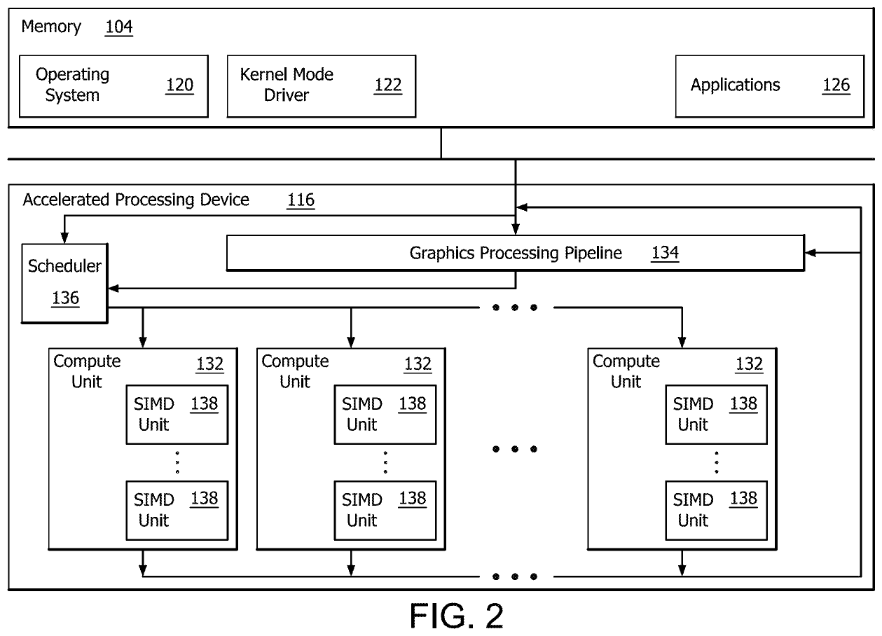

FIG. 2 is a block diagram of the device 100, illustrating additional details related to execution of processing tasks on the APD 116. The processor 102 maintains, in system memory 104, one or more control logic modules for execution by the processor 102. The control logic modules include an operating system 120, a kernel mode driver 122, and applications 126. These control logic modules control various features of the operation of the processor 102 and the APD 116. For example, the operating system 120 directly communicates with hardware and provides an interface to the hardware for other software executing on the processor 102. The kernel mode driver 122 controls operation of the APD 116 by, for example, providing an application programming interface (“API”) to software (e.g., applications 126) executing on the processor 102 to access various functionality of the APD 116. The kernel mode driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that may be suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more SIMD units 138 that perform operations at the request of the processor 102 in a parallel manner according to a SIMD paradigm. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed sequentially on a single SIMD unit 138 or partially or fully in parallel on different SIMD units 138. Wavefronts can be thought of as the largest collection of work-items that can be executed simultaneously on a single SIMD unit 138. Thus, if commands received from the processor 102 indicate that a particular program is to be parallelized to such a degree that the program cannot execute on a single SIMD unit 138 simultaneously, then that program is broken up into wavefronts which are parallelized on two or more SIMD units 138 or serialized on the same SIMD unit 138 (or both parallelized and serialized as needed). A scheduler 136 performs operations related to scheduling various wavefronts on different compute units 132 and SIMD units 138.

The parallelism afforded by the compute units 132 is suitable for graphics related operations such as pixel value calculations, vertex transformations, and other graphics operations. Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

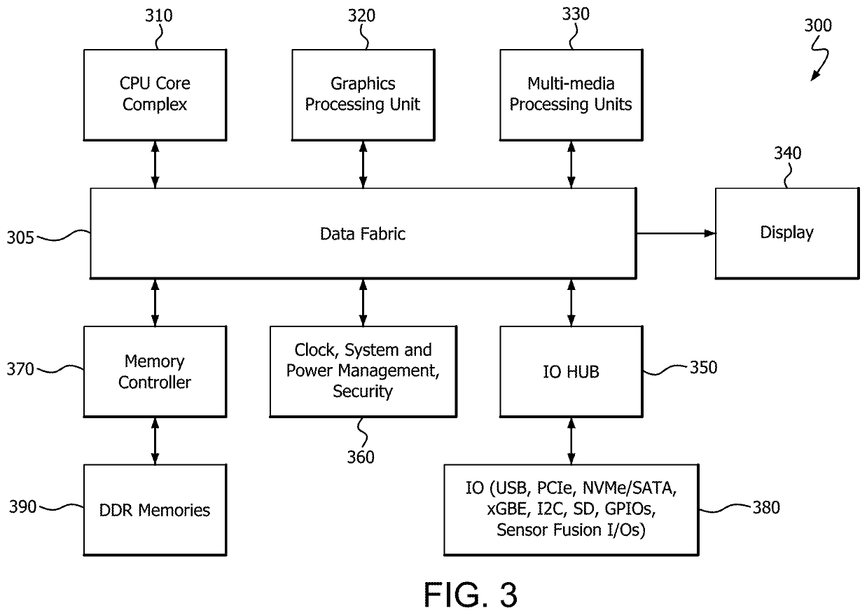

FIG. 3 is a block diagram illustrating an example system-on-a-chip (SoC) device 300 in which one or more features of the examples discussed herein are implemented. SoC device 300 includes a data fabric 305, CPU core complex 310, GPU 320, multi-media processing units (MPUs) 330, display interface 340, I/O hub 350, clock, system and power management, and security block 360, and memory controller 370. Data fabric 305 includes circuitry for providing communications interconnections among the various components of SoC device 300. Any suitable interconnection hardware is used in various implementations. In some implementations, from a physical standpoint, data fabric 305 is implemented either in a central location of the SoC device, or distributed to multiple hubs across the SoC device and interconnected using a suitable communications medium (e.g., a bus). From a logical standpoint, data fabric 305 is located at the center of data flow, and information regarding the idleness of different blocks is concentrated (e.g., stored) in data fabric 305. In some implementations, this information is used in determining an appropriate time to transition into a S0ix sub-state, as described below.

CPU core complex 310 includes one or more suitable CPU cores. Each of the cores in a complex includes a private cache and all of the cores in a complex are in communication with a shared cache. In some implementations, SoC device 300 includes a plurality of CPU core complexes. GPU 320 includes any suitable GPU or combination of GPU hardware. MPUs 330 include one or more suitable MPUs, such as audio co-processors, imaging signal processors, video codecs, and so forth.

Display interface 340 includes any suitable hardware for driving one or more displays. I/O hub 350 includes any suitable hardware for interfacing the data fabric 305 with I/O devices 380. In some implementations, I/O devices 380 include one or more of a universal serial bus (USB), peripheral component interconnect express (PCIe) bus, non-volatile memory host controller interface (NVMe) bus, serial advanced technology attachment (SATA) bus, gigabit Ethernet (xGBE), inter-integrated circuit (I2C) bus, secure digital (SD) interface, general purpose input/output (GPIO) connection, sensor fusion I/O connection, and/or any other suitable I/O hardware. Accordingly, in some implementations, I/O hub 350 includes a USB host controller, PCIe root complex, NVMe host controller, SATA host controller, xGBE interface, I2C node, SD host, GPIO controller, sensor fusion controller, and/or any other suitable I/O device interfaces.

Clock, system and power management, and security block, which is also referred to as a system management unit (SMU 360), includes hardware and firmware for managing and accessing system configuration and status registers and memories, generating clock signals, controlling power rail voltages, and enforcing security access and policy for SoC device 300. In some implementations, security block or SMU 360 is interconnected with the other blocks of SoC device 300 using a system management communication network (not shown). In some implementations, security block 360 is used in managing entry into and exit from multi-tier S0ix states, e.g., using information from data fabric 305.

Memory controller 370 includes any suitable hardware for interfacing with memories 390. In some implementations, memories 390 are double data rate (DDR) memories. Example DDR memories include DDR3, DDR4, DDR5, LPDDR4, LPDDR5, GDDR5, GDDR6, and so forth.

In some examples, SoC device 300 is implemented using some or all of the components of device 100 as shown and described with respect to FIGS. 1 and 2. In some implementations, device 100 is implemented using some or all of the components of SoC device 300.

For completeness, System Power State S0 (awake) is the general working state, where the computing unit is awake. In System Power State S3, the SoC (SoC 300 in FIG. 3 below) information and data is lost and DDR memory (element 390 in FIG. 3 below) is in a self-refresh state. In the S0 state, typically, all subsystems are powered and the user can engage all supported operations of the system, such as executing instructions. If some or all of the subsystems are not being operated, maintaining the S0 state presents an unnecessary waste of power except under certain circumstances. Accordingly, in some examples, if a system in the S0 state meets certain entry conditions it will enter one of a number of power management states, such as a hibernate or a soft-off state (if supported).

Whether the system enters a given power management state from the S0 state depends upon certain entry conditions, such as latency tolerance. Generally speaking, a system in a deeper power management state saves more energy but takes longer to recover to the working or S0 state—i.e., incurs a greater latency penalty—than the system in a power management state that is not as deep. For example, if the operating system (or, e.g., SoC device 300, or processor 102, or data fabric 305, or security block 360) receives latency information, e.g., a latency tolerance report (LTR) from a Peripheral Component Interconnect Express (PCIe) or I/O interface indicating a latency tolerance of a connected peripheral device, this tolerance is compared with the latency required to recover the S0 state from various available power management states. If the latency tolerance is met by one of the power management states, the latency entry condition for the power management state has been met. Assuming that latency tolerance is the only entry condition, for the sake of illustration, and assuming the latency tolerance for more than one power management state has been met, the system enters the deeper power management state to conserve more power in some examples.

In System Power State S3, data or context is saved to RAM and hard drives, fans, and the like are shut down.

In advanced configuration and power interface (ACPI) systems, power on suspend (POS), CPU off, and sleep states are referred to as the S3 state and these terms are used interchangeably herein for convenience. The S3 state is considered to be a deep power management state and saves more power at the cost of a higher latency penalty. Deeper power management states are also referred to interchangeably as lower power management states.

In ACPI systems, hibernate states and soft-off states are referred to as S4 and S5 states respectively, and these terms are used interchangeably herein for convenience. The S5 state is considered to be a deeper power management state than the S4 state, and saves more power at the cost of a higher latency penalty.

In System Power State S4, data or context is saved to disk. The contents of RAM are saved to the hard disk. The hardware powers off all devices. Operating system context, however, is maintained in a hibernate file that the system writes to disk before entering the S4 state. Upon restart, the loader reads this hibernate file and jumps to the system's previous, pre-hibernation location. This state is often referred to as a hibernate state and is generally used in laptops. In a typical S4 state, the system stores its operating system state and memory contents to nonvolatile storage in a hibernate file. Main memory in such systems typically includes dynamic random access memory (DRAM), which requires regular self-refresh. Because the memory state is saved to a hibernation file in nonvolatile storage, the DRAM no longer requires self-refresh and can be powered down. Typically, much of the system is powered down in an S4 state, including static random access memory (SRAM). Accordingly, entering the S4 state has the advantage of reducing power consumption. In determining whether to enter the S4 state, the power consumption savings of the S4 state are balanced against the time required to resume working operation of the system (i.e., time to re-enter the S0 state—the latency penalty) including powering the DRAM and other components, and restoring the memory contents from the hibernation file, for example.

System Power State S5 is similar to the S4 state, with the addition that the operating system context is not saved and therefore requires a complete boot upon wake. In a typical S5 state, the system does not store its operating system and memory state. The S5 state is a deeper and slower state than the S4 state. As in the S4 state, the S5 state saves power by turning off DRAM memory; however it can enter the state more quickly because it does not need to generate a hibernation file. Among other things, these advantages are balanced against the time required to resume the S0 state (i.e., latency penalty) by both powering the DRAM and restarting the user session. The S5 state is similar to a mechanical off state, except that power is supplied to a power button to allow a return to the S0 state following a full reboot.

In the computing world with increased computing requirements, where it is expected that devices are picked up and put down frequently, and the expectation is the device is immediately ready for operation upon pickup, additional power states modes may be necessary. As a result, new S0ix active idle states (there are multiple active idle states, e.g., S0i1, S0i3) may be designed. These active idle states may deliver the same reduced power consumption as the S3 sleep state, but enable a quick wake up time to get back into the full S0 state, allowing the device to become immediately functional.

The S0ix states may include low-power idle modes of the working state S0. The system remains partially running in the low-power idle modes. During low-power idle, the system may stay up-to-date whenever a suitable network is available and also wake when real-time action is required, such as OS maintenance, for example. Low-power idle wakes significantly faster than the S1-S3 states.

Some systems also provide low-power idle states to which the system can transition from the S0 state. In some systems, idle states are considered sub-states of the S0 state, and are referred to as internal states, or S0ix states (in ACPI parlance), and these terms are used interchangeably herein for convenience. As with the S4 and S5 states, whether the system enters an S0ix state from the S0 state depends upon certain entry conditions. The S0ix states can include short idle states and long idle states. In some systems, short-idle states and long-idle states are referred to as S0i1 and S0i3 states, respectively, and these terms are used interchangeably herein for convenience. As with the S4 and S5 states, each of the S0ix states includes various power management interventions.

In an S0i1 state, the system remains largely active. Certain subsystems are shut down or voltage-reduced to save power. For example, in some implementations of an S0i1 state, CPU and/or GPU cores are power gated or turned off (e.g., by one or more corresponding voltage regulators) for a percentage of time. In some implementations, certain power rails are only powered (or fully powered), e.g., by voltage regulators, in the S0 state (i.e., are fully turned off, e.g., by one or more corresponding voltage regulators, in all other system power management states; e.g., S4 or S5 states), and are referred to collectively as the S0 voltage domain. The S0 voltage domain is normally powered by S0 domain voltage regulators at all times. To save power, certain portions of the S0 domain circuitry are shut off in the S0i1 state under certain idle conditions, and such portions of the S0 domain are referred to as on-off regions (ONO). Certain portions of the circuitry are not shut down or reduced in voltage in the S0 power management state. In cases where certain portions of the circuitry are never turned off or reduced in voltage in the S0 state, such portions are referred to as always-on regions (AON).

In the S0i1 state, the display remains on, displaying a static page. In some implementations, the static page is displayed using a panel self-refresh (PSR) mode. Other devices, such as memory controllers, remain on in addition to the display and the data fabric. In some implementations, some or all multimedia processors (e.g., audio co-processors, imaging signal processors, video codecs, etc.) remain on. Because most of the system remains active, including the main memory DRAM, the system can enter the S0i1 state and resume the S0 state from the S0i1 state more quickly (e.g., on the order of micro-seconds in some implementations) than from the S4 and S5 states (e.g., on the order of seconds to over a minute in some implementations). For example, at typical processor speeds, the S0i1 state occurs frequently, such as between keystrokes. This advantage is balanced against power savings that is less dramatic than the S4 and S5 states, for example, due to the main memory DRAM remaining energized.

In an S0i3 state, the system is less active than the S0i1 state. For example, in some implementations of an S0i3 state, various S0 power domain power supply rails supplying components to be shut down in the S0i3 state are gated or turned off at voltage regulators. In some implementations, the gated S0 power domain supply rails are the same rails gated or turned off at voltage regulators in the S3 power state, the voltage regulators are managed as in the S3 state, and all S0 domain power supplies are turned off to save on-die power. Essentially, the S0 voltage domain is shut down in the S0i3 state. S0 domain power rails are used to meet the supply needs of various blocks and/or domains (“IPs”) in a SoC, and examples include VDDCR_SOC, VDDP, VDD18 and VDD33 rails. For example, in some implementations, VDDCR_SOC powers all major non-CPU and/or non-GPU system IPs, this supply rail provides either fixed or variable supply voltage levels to support CPU, GPU, and multi-media processor functionality and data transfer bandwidth and activities. In some implementations, VDDP is a fixed voltage rail that provides a defined digital voltage to support IPs that needs a fixed voltage supply. VDD18 is a 1.8V voltage supply and VDD33 is a 3.3V voltage supply. VDD18 and VDD33 are needed for different I/O applications and specifications.

VDDCR_SOC is used as an example herein for description of power gating or reduction, or frequency reduction, for various states. However in various implementations, other rails or designations are possible. Various S0 domain power supply voltage regulators are turned off to save off-die power in the S0i3 state. Information stored in memory (e.g., SRAM) powered by these supplies is stored (i.e., “backed-up”) to other memory, such as main memory (e.g., DRAM) or a backing store. In some implementations, the Universal Serial Bus (USB) does not actively transfer data in the S0i3 state and enters a suspended mode. Sensing the USB bus to detect a signal to wake up from the suspended mode requires a slower clock than is used for data transfer; accordingly, the clock signal provided to the USB can be shut down, leaving the USB to rely on its own, slower clock. Further, various other voltage domains of the system that power components to be shut down in the S0i3 state, can be turned off or “gated”.

Because less of the system is active in the S0i3 state than in the S0i1 state, the system uses less power than the S0i1 state. This advantage is offset however, as the system cannot resume the S0 state from S0i3 as quickly, for example, due to the time required to bring the powered-off power domains back up to operating voltage, restoring the backed-up information to its original memory (e.g., SRAM), and to restart the USB data transfer clock. In some implementations restoring the backed-up information to its original memory requires the involvement of the OS, BIOS, drivers, firmware, and the like, contributing to the required time.

In order for entry into the S0i3 state from the S0i1 state to yield a net power savings, the system would need to remain in the S0i3 state long enough to offset the power required to effect the various steps involved in entering the S0i3 state from the S0i1 state, and returning to the S0i1 or S0 state from the S0i3 state. The minimum time during which the system would need to remain in the S0i3 state to yield a power savings is referred to as a residency requirement of the S0i3 state, and is an entry condition for the S0i3 state with respect to the S0i1 state in some implementations.

Some systems also provide another form of long-idle power management state to which the system can transition from the S0 state. Such additional long-idle power management state is referred to as an S0i2 state, and these terms are used interchangeably for convenience. In the S0i2 state, the voltage of various supply rails, such as S0 domain power supplies (e.g., VDDCR_SOC) can be reduced to save on-die power. Various voltage regulators are also reduced to save off-die power. As opposed to the S0i3 state, where these voltages are turned off, in the S0i2 state, the voltages are lowered to a level where data state information is retained; i.e., information stored in memory (e.g., SRAM) powered by these supplies is maintained and does not need to be backed-up. In some examples, this level is referred to as a retention voltage or retention level. At the retention level, the memory has enough power to maintain stored information, but not enough power to perform normal operations on the information.

Because more of the system is active in the S0i2 state than in the S0i3 state, the system uses more power in the S0i2 state than in the S0i3 state. However, because less of the system is active in the S0i2 state than in the S0i1 state, the system uses less power in the S0i2 state than in the S0i1 state. The system cannot resume the S0 state from the S0i2 state as quickly as from the S0i1 state, for example, due to the time required to bring the regulated voltages up from the retention level to the normal operating level. Because the system does not need to restore backed-up information or turn S0 voltage supplies back on however (among other reasons), a system in the S0i2 state requires less time to resume the S0 state than from the S0i3 state.

In order for entry into the S0i2 state from the S0i1 (or another) state to yield a net power savings, the system would need to remain in the S0i2 state long enough to offset the power required to effect the various steps involved in entering the S0i2 state from the S0i1 state, and returning to the S0i1 state from the S0i2 state. The minimum time during which the system would need to remain in the S0i2 state to yield a power savings is referred to as the residency requirement of the S0i2 state, and is an entry condition for the S0i2 state in some implementations.

In some implementations, a tiered approach is applied to power management state handling. In some examples, a tiered approach to the S0i2 state includes more than one sub-state between the S0i1 and S0i3 states. In some examples, such sub-states are referred to as S0i2.x sub-states, and these terms are used interchangeably for convenience. In some cases, dividing a low-power state into tiers (e.g., using sub-states) in this way has the advantage of improving or optimizing power savings and recovery time. As with the S0i1, S0i3, S4, and S5 states, each of the S0i2.x sub-states includes various power management interventions. In some examples, the S0i2.x sub-states include power management interventions similar to one another, differing largely (or only) in degree. In various implementations, different S0i2.x sub-states provide different amounts of power savings and incur different amounts of control complexity.

In an example S0i2.0 sub-state, VDDCR_SOC is reduced from its typical operation voltage to a retention voltage. At the retention voltage, VDDCR_SOC supplies enough power to its associated memories (e.g., SRAM) to retain the saved information, but is below the voltage required to read from or write to the SRAM. In this example, the typical operational voltage for VDDCR_SOC is referred to as V_{S0} (e.g., 0.7 volts), and for the S0i2.0 sub-state it is lowered to a retention voltage referred to as V_{S0i2.0} (e.g., 0.6 volts).

In some examples, all clocks associated with VDDCR_SOC are switched off, referred to as F_{S0i2.0} (e.g., 100 megahertz), in order to reduce power consumption due to switching. The phase locked loop or loops used to generate reference clock signals, which can be referred to as CGPLL, remains active.

In an example S0i2.1 sub-state, VDDCR_SOC is reduced from its typical operation voltage to a retention voltage, as in the S0i2.0 sub-state. As mentioned earlier, for this example, the typical operational voltage for VDDCR_SOC is referred to as V_{S0} (e.g., 0.7 volts). For the S0i2.1 sub-state however, VDDCR_SOC is lowered to a retention voltage referred to as V_{S0i2.1} (e.g., 0.5 volts). This assumes that V_{S0i2.1} volts is also an effective retention voltage for the memories associated with VDDCR_SOC (e.g., SRAM) when the SRAM is not expected to be read or written.

Also in this example, all clocks associated with VDDCR_SOC are shut off and the phase locked loop generating the reference clock signals (CGPLL) is shut down to save additional power. In some implementations, various off-die clocks, such as those used for I/O, are switched over from CGPLL to a crystal oscillator or to local ring-oscillator (RO) clock sources.

As can be discerned from these examples, the S0i2.1 sub-state reduces or eliminates more power consumption than the S0i2.0 sub-state when the active clock and data switching power is also cut down, but will take longer to return to the S0 state due to, among other things, a longer time required to transition to the SRAM operating voltage from the retention voltage and extra time to restore the clocks.

In these examples, from a voltage level perspective, the difference between S0i2.x sub-states is primarily (or in some examples, entirely) a matter of degree, as compared with other power management states. For example, both the S0i2.0 and S0i2.1 sub-states reduce the VDDCR_SOC to a retention voltage. The difference, in this example, is the degree to which the voltage is lowered. Stated another way, the S0i2.x sub-states primarily include the same power management interventions with respect to supply voltages, differing only in degree, such as the level of retention voltage. The voltage difference can also be between the reduced operational voltage (reduced switching) and retention (non-switching).

From a clocking perspective, the S0i2.0 and S0i2.1 sub-states can be said to differ in more than degree. In an example S0i2.0 sub-state, clock frequencies are set to F_{S0i2.0} (e.g., 100 megahertz or lower). Maintaining reduced rate clocks in this way, as opposed to shutting them down, allows for wakeup events to occur in the S0 domain in some implementations. An example of such S0 domain wakeup source in the S0i2.0 sub-state is the PCIe in-band wakeup. In a PCIe in-band wakeup, the PCIe end-points (EP) or root are able to imitate a wakeup due to regular PCIe signaling. In the S0i2.1 sub-state, however, all clocks are turned off. Accordingly, in some implementations, no operations (e.g., wakeup events) are possible in the S0 domain. In some implementations, wakeup events in the S0i2.1 sub-state are handled using S5 domain circuitry that remains powered during the S0i2.1 sub-state (and is only turned off during states below S5).

Providing tiered S0i2.x sub-states in this manner also provides the possible advantage of permitting finer calibration of power management states. For example, in some implementations, a system having a greater number of S0i2.x sub-states (e.g., S0i2.2, S0i2.3, and so forth) is able to support finer differences in SRAM retention voltage, and accordingly, latency penalty. In one such example, each deeper sub-state has a retention voltage that is lower by an additional 50 or 100 millivolts, within a range valid for SRAM retention. In principle, the number of S0i2.x sub-states is arbitrary. However, increasing numbers of S0i2.x sub-states create an increased tradeoff between complexity and power savings.

One such low-power idle is illustrated in the system 300 of FIG. 3. System 300 includes a lower-power idle state, such as S0i2 D23, for example. When placed in the D23 state, the state of the memory controller 370 is preserved. The preservation of the state of the memory controller 370 allows a notification by signal and given the always on demand to wake up out of self-refresh and direct the memory controller 370. This ability may be useful for a shared domain device in low power state. The D23 state allows for controlled and faster wake-up of the device from the sleep state than occurs without preservation of the state of memory controller 370. The D23 memory controller state achieves memory self-refresh state while introducing an interlock between data fabric 305, memory controller 370 and SoC 300. This interlock guarantees that memory access through data fabric 305 and memory controller 370 is allowed after voltage is ramped up. The D23 state is so referred because it is associated with the S0i2 state where the voltage can be reduced to the retention or near-retention level. By analogy, the D2 state is where the voltage is not reduced and interlock is not required. D3 is the state associated with the S0i3 or S3 states. Normally, in the D3 state, the data fabric 305 and memory controller 370 state is lost and then needs to be restored on exit.

Memory Controller D23 state reconciles two distinct states—D2 of the memory controller and D3 (or low power state 3) of the memory PHY. In the Memory PHY low power state D3 (named LP3 in some embodiments), the PHY voltage rail is turned off and the PHY is placed in the self-refresh state along with the memory itself. These are key factors for reducing the power consumption in the S0i2 SoC state. At the same time, the memory controller remains in a more active state than it would have been, had the SoC been placed in the S0i3 or S3 states. This more active state (D23) allows for staging an interlock for gradual exit out of S0i2 state. First data fabric 305/memory controller 370 voltage is ramped up, then clocks are restored, and finally the memory PHY is transitioned out of the D3/LP3 state.

The memory controller in D23 state on S0i2 is enabled when on-die hardware and firmware detects the system is in long idle. In the S0i2 state, the display off state triggers the long idle display off state. The I/O remains powered. A long idle time is approximated in the D23 state by powering down the PHY while the DRAM is in refresh and the S3 state may be avoided.

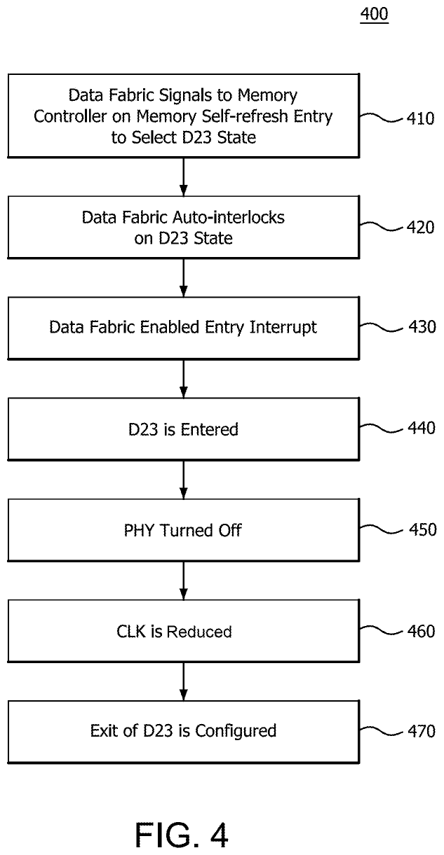

FIG. 4 illustrates a method 400 of entering the D23 state. Once in the S0i2 state based on on-die hardware and firmware detecting system in long idle, the data fabric 305 signals DstateSel to the memory controller 370 on memory self-refresh entry to select the D23 state. The data fabric 305 selects the D23 state as the target state based on a specific metric and SMU notifications at step 410. The memory controller selects the D3 (or LP3) state. The data fabric 305 auto-interlocks on the state at step 420. Exit via WAKE sideband signaling to firmware to clear the register exit block and enables the data fabric C-state entry interrupt at step 430. This enables the SMU 360 to block memory access, reduce data fabric 305 and memory controller 370 clocks, and reduce the SoC voltage to the retention level or near the retention level.

The D23 S0i2 state is entered at step 440 and the memory PHY is turned off at step 450, and the CLK is reduced at step 460 with retention. The exit condition from the D23 state is configured by an external condition or WAKE at step 470.

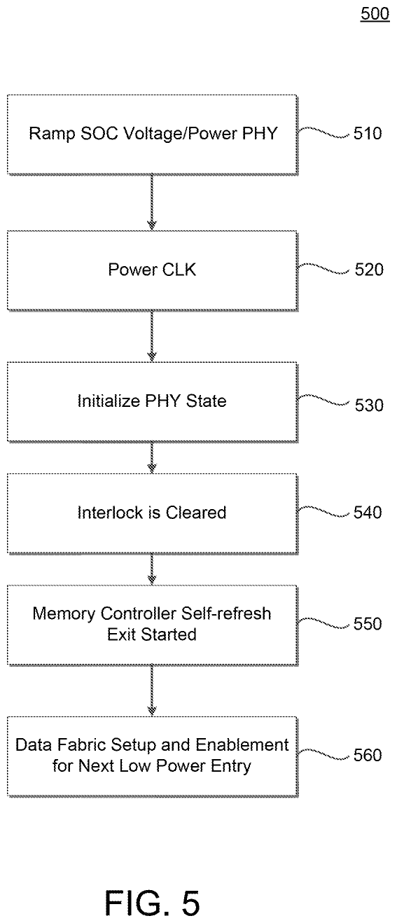

FIG. 5 illustrates a method 500 of exiting the D23 state. The SMU is signaled by inband or outband event to wake up the SoC out of the S0i2 state. The SMU starts the exit flow by ramping up the SoC voltage by powering the PHY on at step 510 and ramping up the data fabric 305 and memory controller 370 clocks at step 520. At step 530, the PHY state is initialized. At step 540, the interlock is cleared. Memory controller 370 self-refresh exit is started only after the WAKE is asserted at step 550 and memory access is unblocked. The memory controller is prohibited to start exiting out of the D23 retention state even if incoming traffic is detected. Other components may be allowed to access the memory even before the voltage is ramped up. Memory controller may provide access to the memory when WAKE is asserted. After waking, the direct memory access (DMA) or processor activity associated with the wake up event is propagated to the memory. The PHY exits the idle state and the memory exits self-refresh. The data fabric 305 setup is undone so the data fabric 305 is enabled for the next low power entry at step 560.

As is understood, SoC reset usually occurs under OS control. In D23 the state is preserved for memory controller 370. A signal may be provided in always on demand to wake up out of self-refresh.

The D23 state saves the system for the components to bring SoC online including, but not limited to, voltage, clocks to resume execution.

In a specific embodiment, the D23 state memory interlock is implemented using two bits/indications. The wake-up out of this idle state is enabled based on an inband or an outband notification (the bit is called SMUWAKE_ENABLE in this specific embodiment). The idle state may be exited via the data fabric disable. The first bit/indication of the two bits/indications allows for only specific wake up events, qualified by the SMU to start the wake up process. The second bit/indication of the two bits/indications allows the exit only when the second bit (disable to exit data fabric low power state) is cleared, which occurs when voltages are ramped up to the safe level.

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, the input driver 112, the input devices 108, the output driver 114, the output devices 110, the accelerated processing device 116, the scheduler 136, the graphics processing pipeline 134, the compute units 132, the SIMD units 138) may be implemented as a general purpose computer, a processor, or a processor core, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

1. A method for power management in a computer processing device, the method comprising:
signaling a memory controller to enter a long-idle state in a low-power idle mode, wherein the memory controller is associated with a memory,
wherein the low-power idle state comprises:
blocking memory access;
reducing clock rates of clocks of a data fabric and the memory controller;
reducing a system-on-a-chip (SoC) voltage, wherein the reduced SoC voltage provides power to retain information in associated memory; and
turning a physical interface (PHY) voltage off.

2. The method of claim 1, wherein the blocking of memory access is performed by the data fabric.

3. The method of claim 1, wherein the long-idle state is selected based on a system management unit (SMU) signaling.

4. The method of claim 1, wherein the blocking of memory access is performed by a system management unit (SMU).

5. The method of claim 1, wherein the SoC voltage is reduced to a retention level.

6. The method of claim 1, wherein the SoC voltage is reduced to near a retention level.

7. A method for power management in a computer processing device, the method comprising:
signaling a system-on-a-chip (SoC) to wake up based on an activity associated with a wake up event;
starting an exit flow by ramping up SoC voltage and ramping up clocks of a data fabric and a memory controller, wherein the memory controller is associated with a memory, wherein the SoC voltage is ramped up from an amount of voltage that allows for information to be retained in the associated memory;
unblocking memory access to the memory;
propagating the activity associated with the wake up event to the memory;
exiting a long-idle state in a low-power idle mode by turning on a physical layer (PHY) voltage; and
exiting self-refresh by the memory.

8. The method of claim 7, wherein the unblocking memory access is performed by the data fabric.

9. The method of claim 7, wherein the signaling is a system management unit (SMU) signaling.

10. The method of claim 7, wherein the SoC voltage is ramped up from a retention level or near a retention level.

11. The method of claim 7, wherein signaling to wake up SoC is based on an inband event.

12. The method of claim 7, wherein signaling to wake up SoC is based on an outband event.

13. The method of claim 7, wherein the propagated activity includes direct memory access (DMA) activity.

14. The method of claim 7, wherein the propagated activity includes processor activity.

15. A computer processing device, the device comprising:
at least one processor;
a data fabric; and
a memory controller, wherein the memory controller is associated with a memory;
wherein the at least one processor, the data fabric, and the memory controller include circuitry configured to:
signal a system-on-a-chip (SoC) to wake-up based on an activity associated with a wake up event;
start an exit flow by ramping up SoC voltage and ramping up clocks of the data fabric and the memory controller, wherein the SoC voltage is ramped up from an amount of voltage that allows for information to be retained in the associated memory;
unblock memory access to the memory;
propagate the activity associated with the wake up event to the memory;
exit a long-idle state in a low-power idle mode by turning on a physical layer (PHY) voltage; and
exit self-refresh by the memory.

16. The device of claim 15, wherein the unblocking memory access is by the data fabric.

17. The device of claim 15, wherein the signaling is a system management unit (SMU) signaling.

18. The device of claim 15, wherein the SoC voltage is ramped up from a retention level or near a retention level.

19. The device of claim 15, wherein signaling to wake up SoC is based on one of an inband event and an outband event.

20. The device of claim 15, wherein the propagated activity includes at least one of direct memory access (DMA) activity and processor activity.
